(19) United States
(12) Patent Application Publication
(10) Pub. No.: US 2011/0254478 A1
(43) Pub. Date: Oct. 20, 2011

(54) Motor System and Method for Operating a Motor System

(75) Inventors: Thomas Poetzl, Winnenden (DE); Manfred Spraul, Stuttgart (DE)

(73) Assignee: Robert Bosch GbmH, Stuttgart (DE)

(21) Appl. No.: 13/123,904

(22) PCT Filed: Aug. 19, 2009
(86) PCT No.: PCT/EP2009/060707

§ 371 Date: Jul. 5, 2011

(30) Foreign Application Priority Data
Oct. 14, 2008 (DE) 10 2008 042 805.1

(51) Int. Cl. H02P 6/14

(52) U.S. Cl. 318/400.3

(57) ABSTRACT

A method for operating a drive unit for an electric motor, wherein the drive unit has a drive circuit for driving the electric motor and an intermediate circuit, which is connected upstream of the drive circuit, in particular having an intermediate circuit capacitor. The method includes supplying an actuating variable for driving the electric motor. The method further includes adjusting a variable input voltage and supplying the adjusted input voltage to the drive unit via the intermediate circuit. In addition, the method includes operating the drive circuit as a function of an available intermediate circuit voltage, which is dependent on the adjusted input voltage, and as a function of the actuating variable in order to drive the electric motor in accordance with the actuating variable.

### TECHNICAL FIELD

The invention relates, in general, to a motor system having an electric motor which is driven by means of a power-electronics drive circuit and is supplied with power by a DC voltage source.

### PRIOR ART

Electric motors which can be driven in a variable manner are increasingly being used in vehicles. To this end, an electric motor of this kind is generally driven by a drive device having a power-electronics drive circuit, for example a B6 bridge, an H bridge and the like which have semiconductor switches. The drive circuit is generally controlled by a control unit which switches the semiconductor switches on or off.

Furthermore, the drive device has, at the input end of the drive circuit, a passive circuit arrangement which generally has at least one capacitor which is generally called the intermediate circuit capacitor. The voltage across the intermediate circuit capacitor varies depending on the driving of the drive circuit by a control unit and on account of parasitic resistances, and a voltage and current ripple are produced, this requiring corresponding dimensioning of the intermediate circuit capacitor. On account of the considerable loading of the intermediate circuit capacitor on account of the produced voltage ripple and the resultant requisite dimensioning, a considerable portion of the overall structural volume of the drive device for the electric motor is determined by the size of the intermediate circuit capacitor. In the future, the structural volume of the discrete components in the intermediate circuit will further dominate the structural volume of the control unit and of the drive circuit since the control unit and the drive circuit are being increasingly miniaturized and, on account of increasing EMC requirements, more components are having to be arranged in the intermediate circuit.

It is also known to drive electric motors in motor systems by means of a DC voltage converter, which generates a different and/or stabilized intermediate circuit voltage from the supply voltage of an on-board electrical system, in order to drive the electric motor with a desired voltage.

The object of the present invention is to provide a drive device for an electric motor in which the intermediate circuit capacitor can be provided with the smallest possible capacitor value, so that the physical size of the intermediate circuit capacitor can be reduced.

### DISCLOSURE OF THE INVENTION

This object is solved by a method for driving a motor system as claimed in claim 1 and also by an apparatus, a drive system and a motor system as claimed in the coordinate claims.

Further refinements of the invention are specified in the dependent claims.

According to a first aspect, a method for operating a drive unit for an electric motor is provided, wherein the drive unit has a drive circuit for driving the electric motor and an intermediate circuit, which is connected upstream of the drive circuit, in particular having an intermediate circuit capacitor. The method comprises the following steps:
supplying an actuating variable for driving the electric motor;
adjusting a variable input voltage and supplying the adjusted input voltage to the drive unit via the intermediate circuit;
operating the drive circuit as a function of an available intermediate circuit voltage, which is dependent on the adjusted input voltage, and as a function of the actuating variable in order to drive the electric motor in accordance with the actuating variable.

One idea of the above method is that of minimizing the structural volume of the intermediate circuit, in particular of an intermediate circuit capacitor arranged therein, by a lower loading of the intermediate circuit capacitor being provided. This is achieved by the AC loading of the intermediate circuit capacitor being reduced. The effective current through the intermediate circuit, which effective current is critical for the AC loading of an intermediate circuit capacitor, depends on the input current and on the current which is drawn by the drive circuit, that is to say on the input voltage and/or driving of the drive circuit. The current in the drive circuit can be influenced by adapting the applied intermediate circuit voltage which depends on the input voltage. As a result, the effective current through the intermediate circuit capacitor can also be adjusted as a function of the voltage at the input end of the drive circuit, which voltage also corresponds to the voltage across the intermediate circuit capacitor. For this reason, the above method can make provision for both adjusting the input voltage and driving the control unit such that the voltage across the intermediate circuit capacitor is adjusted as a function of the effective current through the intermediate circuit capacitor in order to minimize the AC loading of the intermediate circuit capacitor as far as possible.

Furthermore, the variable input voltage can be adjusted as a function of the actuating variable and/or as a function of a motor state variable, in particular a rotation speed, a torque, a motor current, one or more phase voltages, and/or as a function of a state variable of the drive circuit, in particular of its power loss, and/or as a function of a state variable of the intermediate circuit, in particular of an intermediate circuit voltage or a current through the intermediate circuit capacitor. In particular, the actuating variable can correspond to an electrical power, a mechanical power, the desired rotation speed, the desired torque, the motor current, a motor voltage, an angular position or the phase voltage.

According to one embodiment, the input voltage can be adjusted and the drive circuit can be operated in accordance with a function in the case of which the effective current through a capacitor of the intermediate circuit is minimized.

Provision can be made for the input voltage to be adjusted and the drive circuit to be operated in accordance with a function in the case of which the losses in the DC/DC converter are minimized without prespecified effective currents through a capacitor of the intermediate circuit being exceeded.

Furthermore, the function for adjusting the input voltage during operation or during an explicit learning phase can be learnt by varying the input voltage and driving the electric motor using the drive circuit.

In particular, the one or more operating points of the at least one prespecified actuating variable can be stored in a characteristic map.

Furthermore, the input voltage can be adjusted and the drive circuit can be operated with the aid of a gradient descent method.

An apparatus for operating an electric motor is provided according to a further aspect, said apparatus comprising:
a drive circuit for driving the electric motor,
an intermediate circuit, which is arranged at the input end of the drive circuit and which has, in particular, an intermediate circuit capacitor;
a control unit, which is designed
   to receive an actuating variable;
   to output an adjustment variable which causes a variable input voltage to be output to the drive circuit via the intermediate circuit;
in order to operate the drive circuit so that the electric motor is driven as a function of an available intermediate circuit voltage, which is dependent on the adjusted input voltage, and as a function of the actuating variable.

A drive system for operating an electric motor is provided according to a further aspect, said drive system comprising:
the above apparatus;
a voltage converter for receiving the adjustment variable in order to supply the variable input voltage as a function of the adjustment variable.

A motor system having an electric motor and having the above drive system is provided according to a further aspect.

### BRIEF DESCRIPTION OF THE DRAWINGS

Several embodiments will be explained in greater detail below with reference to the appended drawings, in which:

FIG. 1 is a schematic illustration of a motor system having a drive device which has an intermediate circuit capacitor; and

FIG. 2 shows a graph for illustrating the dependence of an effective current, which is standardized to the effective current in the electric motor, through the intermediate circuit capacitor on a modulation level.

### DESCRIPTION OF EMBODIMENTS

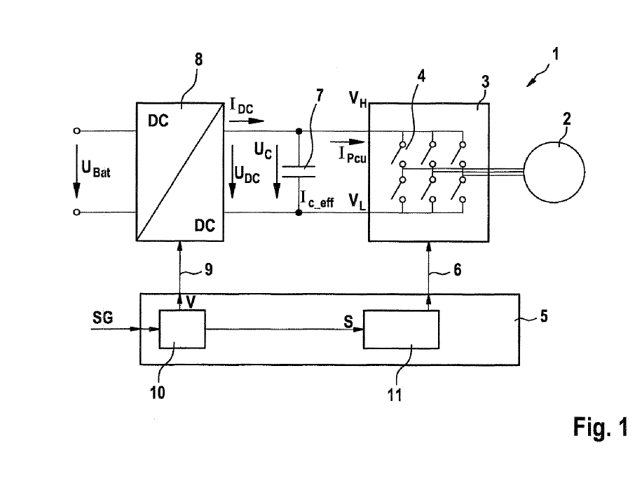

FIG. 1 is a schematic illustration of a motor system 1 having an electric motor 2 which can be, for example, in the form of a synchronous motor. The electric motor can be of multiphase form. In the present case, the electric motor 2 has three phases.

The electric motor 2 is driven by a power-electronics drive circuit 3. In the embodiment of FIG. 1, the drive circuit 3 is in the form of a B6 bridge circuit which has a number of inverter branches which corresponds to the number of phases of the electric motor 2. Each inverter branch has semiconductor switches 4, specifically a pull-high switch and a pull-low switch. In each case one of the pull-high switches and one of the pull-low switches 4 are arranged in a row between a high intermediate circuit potential V_{H} and a low intermediate circuit potential V_{L}. A corresponding phase for being supplied to the electric motor 2 is tapped off between the pull-high switch and the pull-low switch 4 of each of the inverter branches. The pull-high switch therefore pulls the phase, which can be tapped off, of the inverter branch to the high intermediate circuit potential V_{H} and the pull-low switch therefore pulls the phase, which can be tapped off, to the low intermediate circuit potential V_{L}. Each of the pull-high or pull-low switches 4 can be in the form of a power transistor, for example a field-effect transistor, a thyristor or the like, and is driven by a control unit 5 by suitable control signals which are fed, for example to a corresponding gate connection, via control lines 6.

Instead of the shown drive circuit 3 with the B6 bridge circuit, other switching power-electronics drive circuits can also be used, for example an H bridge and the like.

At the input end, the drive circuit 3 is connected to an intermediate circuit which contains intermediate circuit capacitor 7. The intermediate circuit can have further passive components, in particular an inductor coil. The intermediate circuit capacitor 7 is connected to the high intermediate circuit potential V_{H} by way of one connection and to the low intermediate circuit potential V_{L} by way of a further connection. The intermediate circuit capacitor 7 serves to reduce the sudden loadings at the input end of the drive circuit 3 which are produced by switching the semiconductor switches 4 in the drive circuit 3, in order to lower the loading on a source of the power supply.

The high and the low intermediate circuit potential V_{H}, V_{L} are supplied by a voltage converter 8, in particular a DC voltage converter, which, at the input end, is connected to an on-board electrical system of a motor vehicle or generally to an energy source. In the case of a motor vehicle, the DC voltage converter 8 is connected, at the input end, to a battery (not shown) of the motor vehicle which provides a battery voltage U_{Bat}. The DC voltage converter 8 can be driven in a variable manner, that is to say the output voltage U_{DC} of the DC voltage converter 8 can be adjusted in a variable manner in accordance with a DC voltage converter actuating value V which is supplied to the DC voltage converter 8, for example in the form of an electrical signal or in the form of a digital or analog variable, via an adjustment line 9.

A control unit 5 which is connected both to the DC voltage converter 8 and to the drive circuit 3 is also provided. The control unit 5 is supplied from the outside with an actuating variable SG as a prespecified value which indicates a motor variable with which the electric motor 2 is intended to be driven. The actuating variable can correspond, for example, to an electrical power, a mechanical power, the desired rotation speed, the desired torque, the motor current, a motor voltage, an angular position or the phase voltage. The manner in which the electric motor 2 is intended to be driven can be deduced from the actuating variable SG, so that the electric motor 2 behaves in accordance with the prespecified actuating variable SG. The control unit 5 can then drive the DC voltage converter 8 and the drive circuit 3 such that the motor variable which corresponds to the actuating variable SG is supplied.

In order to reduce the physical size of the intermediate circuit capacitor 7, it is expedient to reduce its electrical loading. The AC loading of the intermediate circuit capacitor 7 is calculated, in general, using the following formula:

I_{C}_{_{eff}}={square root over (∫₀^{τ}(i_{DCDC}(t)−i_{PCU}(t))² dt)}

where I_{c}_{_{—}}_{eff} corresponds to the effective current through the intermediate circuit capacitor, i_{DCDC}(t) corresponds to the current supplied by the DC voltage converter 8, and i_{PCU}(t) corresponds to the (input-end) current which is drawn by the drive circuit 3. It can be seen that the magnitude of the effective current I_{c}_{_{—}}_{eff} through the intermediate circuit capacitor 7 can be reduced by approximating the converter current i_{DCDC}(t) and the current through the control circuit i_{PCU}(t). The average value and the effective value of the current through the drive circuit 3 can be influenced by the level of an intermediate circuit voltage U_{c} which is present across the intermediate circuit capacitor 7.

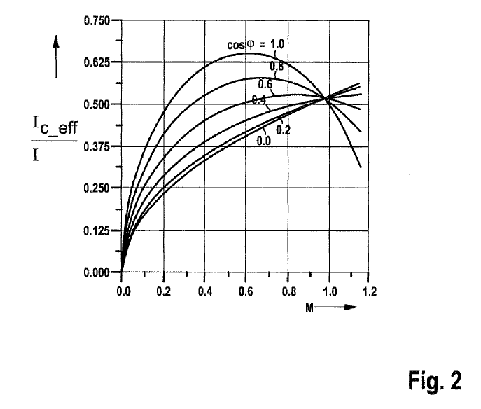

This can be seen in the graph in FIG. 2. Said graph in FIG. 2 shows an effective current I_{c}_{_{—}}_{eff} through the intermediate circuit capacitor I_{c}_{_{—}}_{eff}, which is standardized to the effective current in the electric motor 2, plotted against a modulation level M. The modulation level M behaves in an inversely proportional manner to the intermediate circuit voltage U_{c} and can therefore be influenced by means of the DC voltage converter 8. The parameter of the characteristic curves shown in FIG. 2 is the power factor cos(φ), which can be established, in general, by the quotient of the active power divided by the apparent power of the electric motor. φ corresponds to the phase angle between current and voltage.

In order to minimize the effective current I_{c}_{_{—}}_{eff} through the intermediate circuit capacitor 7 as far as possible, the control unit 5 controls the DC voltage converter 8 in a suitable manner. The drive circuit 3 is appropriately driven by a natural voltage u_{DC} and the prespecified actuating variable SG. In this case, the control unit 5 is intended to drive the DC voltage converter 8 only in such a way that output voltages are adjusted within a voltage range. The voltage range is limited to voltages at which the requirement made of the electric motor 2, which is prespecified by the actuating variable SG, can be maintained, the drive circuit 3 does not fall into an undervoltage mode, or the dielectric strengths of the capacitor, which supplies the intermediate circuit capacitance, and of the semiconductor switches in the drive circuit 3 are not exceeded.

The drive circuit 3 can, for example by varying a duty ratio of a pulse-width-modulated drive means or by varying a duty ratio of a space vector modulation, provide different powers to the electric motor 2. The modulation period duration of the space vector modulation can also be prespecified by the control unit 5. The control unit 5 therefore has degrees of freedom when selecting the drive means of the DC voltage converter 8 and of the drive circuit 3 in order to adjust the motor variable prespecified by the actuating variable SG.

By way of example, provision may be made for the output voltage u_{DC} of the DC voltage converter 8 to be set as low as possible in order to minimize the effective current I_{c}_{_{—}}_{eff} through the intermediate circuit capacitor 7. That is to say, the output voltage of the DC voltage converter 8 should be selected such that the power required for the electric motor 2 can still be reached and the drive circuit 3 can be operated, that is to say the drive circuit 3 does not enter an undervoltage mode.

To this end, the control unit 5 has, for example, a characteristic map block 10 which is supplied with the externally supplied actuating variable SG as an input variable and which, as a function of the actuating variable SG, supplies the DC voltage converter actuating value V to the DC voltage converter 8 and a drive circuit actuating value S to a pulse generating unit 11. The characteristic map block 10 can have a characteristic map in which, for example, an effective current I_{c}_{_{—}}_{eff} is taken into account as a function of the voltage U_{c} present across the intermediate circuit capacitor 7. Further input variables of the characteristic map block 10 can be measurement variables, for example the motor rotation speed and/or the angular position of a rotor of the electric motor 2, the phase currents, the phase voltages and an output current I_{DCDC} of the DC voltage converter 8 which can likewise be measured. It is likewise possible to determine the DC voltage converter actuating value V independently of the supplied actuating variable SG, that is to say only on the basis of measurement variables. As an alternative, instead of or in addition to the supplied actuating variable SG, the current actual value of this variable could be used as an input variable for the characteristic map. As an alternative to a characteristic map, V could also be determined from the indicated input variables by means of an algorithm or formulae stored in a processor.

The characteristic map can be statically prespecified. It is likewise possible to generate or to modify the characteristic map during operation or in a learning mode by the optimum operating points of the DC voltage converter 8 and of the drive circuit 3 being determined for various operating points with different actuating variables SG, and corresponding data sets being stored in the characteristic map in order to be called up later.

The optimization target—irrespective of whether a static characteristic map or optimization during operation is used—may not only be the simple minimization of the effective current I_{c}_{_{—}}_{eff} in the intermediate circuit capacitor 7. For example, it is also advantageous to keep the capacitor current and therefore the heating of the intermediate circuit capacitor below defined limit values. The limit values could, for example, also be dependent on the temperature and/or the length of the current loading of the intermediate circuit capacitor. If the limit values are exceeded, the motor current could be immediately reduced by means of the pulse generating unit 11—at the cost of the motor power, that is to say with disregard to the prespecified actuating variable SG. As soon as a “better” DC voltage converter actuating value V has been found/set, the pulse generating unit 11 can again control the switches 4 such that the higher motor current is supplied and that therefore the actuating variable SG is observed.

In addition to the optimization target of reducing the intermediate circuit current, there may be further optimization targets, for example reducing the losses in the voltage converter 8.

The pulse generating unit 11 generates the drive pulses for the pull-high switches and pull-low switches 4 of the drive circuit 3 as a function of the drive circuit actuating value S, which prescribes a duty ratio of a space vector modulation for example, in order to drive said drive circuit in accordance with the drive circuit actuating value S.

The output voltage of the DC voltage converter 8 can be adapted and the drive circuit 3 can be driven in an adaptive manner by the effective current through the intermediate circuit capacitor 7 being detected, for example with the aid of a current transformer or a current measuring resistor, and the effective current through the intermediate circuit capacitor 7 being minimized, for example with the aid of an optimization method, for example the gradient descent method, by varying the converter voltage output by the DC voltage converter 8 and the duty ratio or generally by varying the drive circuit actuating value S and the DC voltage converter actuating value V. In this way, the characteristic map for the motor system can be learnt and stored, for example, in a suitable memory unit (not shown) in the characteristic map block 10. Adaptation on-the-fly in the case of slow changes in the actuating variable is also possible with this method.

Provision may also be made for the output voltage of the DC voltage converter 8 to be adjusted to a specific voltage with the aid of the DC voltage converter actuating value V. The effective current I_{c}_{_{—}}_{eff} through the intermediate circuit capacitor 7 is measured directly or estimated from the motor state variables. If the effective current I_{c}_{_{—}}_{eff} is too high, the output voltage of the DC voltage converter 8 is modified until the effective current I_{c}_{_{—}}_{eff} is low again, that is to say falls below a specific current threshold value.

The control unit 5, the drive circuit 3 and the intermediate circuit capacitor 7 are usually provided as a single unit in a controller for an electric motor 2. When the above motor system is realized, an adjustment line 9 for transmitting the DC voltage converter actuating value V has to be provided from the control unit 5 to a DC voltage converter 8, which is arranged separately and remote from the controller, in order to drive the DC voltage converter 8 in a variable manner for the purpose of minimizing the AC loading of the intermediate circuit capacitor 7.

1. A method for operating a drive unit for an electric motor, wherein the drive unit has a drive circuit for driving the electric motor and an intermediate circuit, which is connected upstream of the drive circuit, in particular having an intermediate circuit capacitor, comprising:
supplying an actuating variable for driving the electric motor;
adjusting a variable input voltage and supplying the adjusted input voltage to the drive unit via the intermediate circuit; and
operating the drive circuit as a function of an available intermediate circuit voltage, which is dependent on the adjusted input voltage, and as a function of the actuating variable in order to drive the electric motor in accordance with the actuating variable.

2. The method as claimed in claim 1, wherein the variable input voltage is adjusted as a function of the actuating variable and/or as a function of a motor state variable, in particular a rotation speed, a torque, a motor current, one or more phase voltage(s), and/or as a function of a state variable of the drive circuit, in particular of its power loss, and/or as a function of a state variable of the intermediate circuit, in particular of an intermediate circuit voltage or a current through the intermediate circuit capacitor.

3. The method as claimed in claim 1, wherein the actuating variable corresponds to an electrical power, a mechanical power, the desired rotation speed, the desired torque, the motor current, a motor voltage, an angular position or the phase voltage.

4. The method as claimed in claim 1, wherein the input voltage is adjusted and the drive circuit is operated in accordance with a function in the case of which the effective current through a capacitor of the intermediate circuit is minimized.

5. The method as claimed in claim 1, wherein the input voltage is adjusted and the drive circuit is operated in accordance with a function in the case of which the losses in a voltage converter are minimized without prespecified effective currents through a capacitor of the intermediate circuit being exceeded.

6. The method as claimed in claim 4, wherein the function for adjusting the input voltage during operation or during an explicit learning phase is learnt by varying the input voltage and driving the electric motor using the drive circuit.

7. The method as claimed in claim 4, wherein the one or more operating points of the at least one prespecified actuating variable is/are stored in a characteristic map.

8. The method as claimed in 4, wherein the input voltage is adjusted and the drive circuit is operated with the aid of a gradient descent method.

9. An apparatus for operating an electric motor, comprising:
a drive circuit configured to drive the electric motor,
an intermediate circuit, which is arranged at the input end of the drive circuit and which has, in particular, an intermediate circuit capacitor;
a control unit configured to:
receive an actuating variable; and
output an adjustment variable which causes a variable input voltage to be output to the drive circuit via the intermediate circuit;
in order to operate the drive circuit so that the electric motor is driven as a function of an available intermediate circuit voltage, which is dependent on the adjusted input voltage, and as a function of the actuating variable.

10. A drive system for operating an electric motor, comprising:
an apparatus for operating an electric motor that includes:
a drive circuit configured to drive the electric motor,
an intermediate circuit, which is arranged at the input end of the drive circuit and which has, in particular, an intermediate circuit capacitor;
a control unit configured to:
receive an actuating variable; and
output an adjustment variable which causes a variable input voltage to be output to the drive circuit via the intermediate circuit;
in order to operate the drive circuit so that the electric motor is driven as a function of an available intermediate circuit voltage, which is dependent on the adjusted input voltage, and as a function of the actuating variable; and
a voltage converter for receiving the adjustment variable in order to supply the variable input voltage as a function of the adjustment variable.

11. (canceled)
